(19) United States
(12) Patent Application Publication
(10) Pub. No.: US 2025/0307698 A1
(43) Pub. Date: Oct. 2, 2025

(54) PROCESSING MODEL OUTPUTS

(71) Applicant: Wells Fargo Bank, N.A., San Francisco, CA (US)

(72) Inventors: Rathiesh Naidu Anarajula, Hyderabad (IN); Murali Ravipudi, Nanakramguda (IN); Naresh Dindi, Hyderabad (IN); Krishnakumar Chellappa, Indian Land, SC (US)

(21) Appl. No.: 18/623,622

(22) Filed: Apr. 1, 2024

(51) Int. Cl. G06N 20/00; G06N 5/022

(52) U.S. Cl. CPC G06N 20/00; G06N 5/022

(57) ABSTRACT

This disclosure describes techniques for capturing data points from a collection of models. In one example, this disclosure describes a method that includes capturing a sequence of model output data generated by a model, wherein the sequence of model output data includes information about a plurality of predictions made by the model; selecting, based on configuration settings, a process to perform on the sequence of model output data, wherein the process is selected from a plurality of available processes; performing the selected process, based on at least a portion of the sequence of model output data, to generate information about performance of the model over time; and sending, to a downstream system, control signals to modify operation of the downstream system based on the information about performance of the model over time.

### TECHNICAL FIELD

This disclosure relates to computing systems, and more specifically, to systems using one or more models to generate a sequence of output data in response to input data.

### BACKGROUND

Once trained, an artificial intelligence model is capable of generating a prediction or other output in response to input data. Predictions generated by such models can be used for a wide variety of purposes, including for natural language processing, computer vision, recommendation systems, and predictive analytics.

Some organizations use a collection of many models, each trained to perform a specific task. In such an environment, some of these models may perform tasks that are related to other models, but other models might perform tasks that not related to other models, and therefore perform tasks relatively independent of the other models.

### SUMMARY

This disclosure describes techniques for capturing data points generated by a collection of models and processing the captured data in a timely way to enhance the operation, productivity, and/or usefulness of the system that uses the collection of models. Processing the captured data, as described herein, may result in improving the accuracy of the models, gaining insights into model operation based on analytics performed on the captured data, assessing the health of the models, and/or productively load balancing resources consumed by the system in which the models operate.

In some examples, the captured data points correspond to model outputs generated by artificial intelligence models. Such data points may include predictions made by such models, input the models used to generate the predictions, model execution time, metadata associated with a model's operation, and any other data that may provide insights into model operations.

Analysis of captured data points may be based on model output data points captured across many time frames, so that analysis of the accuracy, health, operation, and other aspects of a model can be assessed broadly over time, rather than in based on individual model predictions or based on a specific timeframe. Further, analysis of captured data points may be based on model output data points captured across multiple models, so that accuracy, health, operations, and other aspects of a broader system using multiple models can be assessed more comprehensively.

In some examples, this disclosure describes operations performed by a computing system in accordance with one or more aspects of this disclosure. In one specific example, this disclosure describes a method comprising capturing, by a computing system, a sequence of model output data generated by a model, wherein the sequence of model output data includes information about a plurality of predictions made by the model, and wherein each prediction in the plurality of predictions is generated by the model in response to a different set of model input data; selecting, by the computing system and based on configuration settings, a process to perform on the sequence of model output data, wherein the process is selected from a plurality of available processes; performing the selected process, by the computing system and based on at least a portion of the sequence of model output data, to generate information about performance of the model over time; and sending, by the computing system and to a downstream system, control signals to modify operation of the downstream system based on the information about performance of the model over time.

In another example, this disclosure describes a system comprising a storage system and processing circuitry having access to the storage system, wherein the processing circuitry is configured to carry out operations described herein. In yet another example, this disclosure describes a computer-readable storage medium comprising instructions that, when executed, configure processing circuitry of a computing system to carry out operations described herein.

The details of one or more examples of the disclosure are set forth in the accompanying drawings and the description herein. Other features, objects, and advantages of the disclosure will be apparent from the description and drawings, and from the claims.

### BRIEF DESCRIPTION OF THE DRAWINGS

FIG. 1A is a conceptual diagram illustrating an example system for processing outputs generated by one or more models, in accordance with one or more aspects of the present disclosure.

FIG. 1B is a conceptual diagram illustrating an example flow diagram of how model outputs generated by an artificial intelligence model may be used, in accordance with one or more aspects of the present disclosure.

FIG. 2 is a block diagram illustrating an example system for processing outputs generated by one or more models, in accordance with one or more aspects of the present disclosure.

FIG. 3 is a flow diagram illustrating operations performed by an example computing system, in accordance with one or more aspects of the present disclosure.

### DETAILED DESCRIPTION

In the currently evolving world of artificial intelligence and machine learning, model output data points can be a very critical asset for monitoring models and gaining insights into model operation. This disclosure describes a framework that captures data points from models, such as custom deployed artificial intelligence models. As described herein, model output data is streamed from models and captured in near or seemingly-near real time, enabling effective model monitoring and other processes to be performed in a timely manner on the streamed data. The streamed data captured by the framework may include information from model scoring operations, which may include model request inputs and the corresponding response or prediction, along with information about model operation, such as model execution time and metadata. As appropriate, the framework directs data to streaming systems, platforms, or modules for further processing, monitoring or for other uses. Streaming, capturing, and processing data points derived from model outputs, as described herein, enables a number of benefits and advantages, including effective model and system monitoring, as well as opportunities to improve operation of the models and/or a broader system in which the models operate.

In some examples, the described framework is capable of monitoring model prediction accuracy, including raising alerts and/or triggering retraining as needed or desired. Such accuracy monitoring may involve feature to response distribution monitoring.

The framework may also be capable of performing analytics. For example, the framework may perform analytical studies using prediction data generated by the models in real time or near-real time. The framework may generate analytics reports or business intelligence reports that can be evaluated and acted upon by other systems and/or human personnel (e.g., administrators or business decisionmakers).

The framework may also be capable of monitoring the health of models, such as based on model scoring execution times and/or request and response times. The framework may generate alerts and/or trigger remediation procedures to address unacceptable execution times, near or actual failures to comply with service level agreements, lagging or high variance request and response times, and/or other issues. In some examples, model health and performance can be optimized based on model metadata.

The framework may also perform automatic resource scaling and/or load balancing, which may be based on the predictions generated by the models. Such load balancing may involve allocating more (or less) resources to various tasks or supporting systems and/or generating recommendations or alerts based on load balancing analyses. In some examples, infrastructure can be optimized for future needs, especially where a model predicts more traffic for specific purposes during upcoming timeframes or seasonal timeframes. The framework enables systems to be automatically scaled based on model performance analyses or predictions about model execution response times.

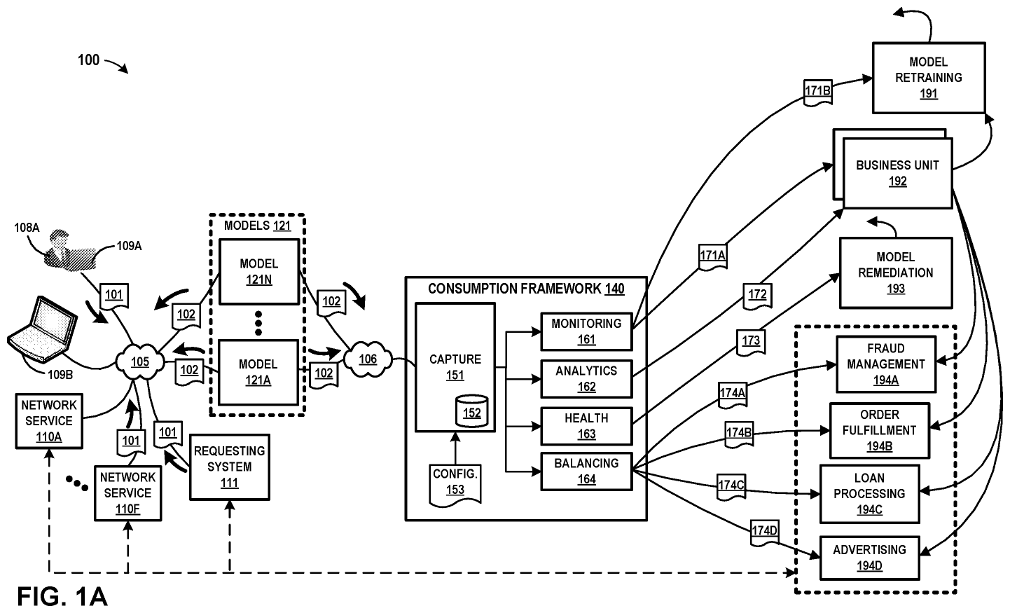

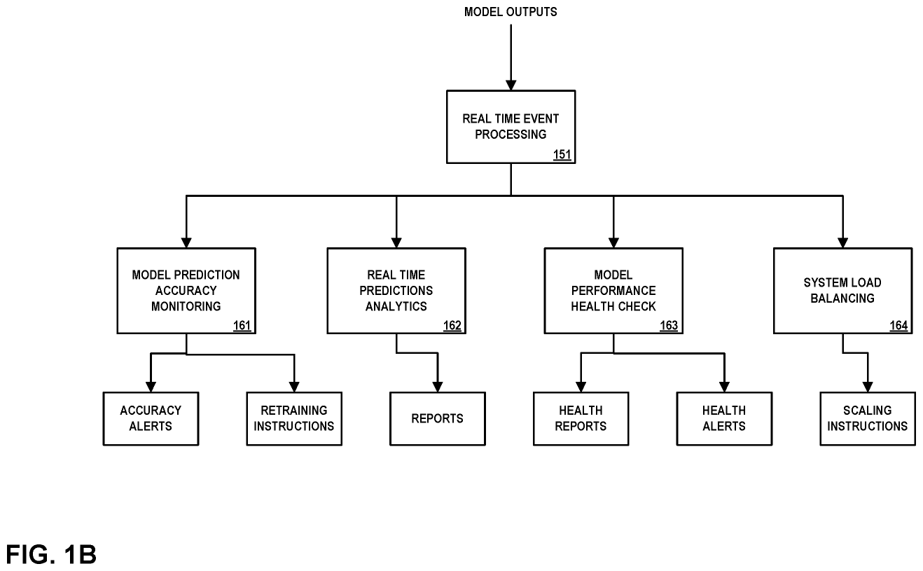

FIG. 1A is a conceptual diagram illustrating an example system for processing outputs generated by one or more models, in accordance with one or more aspects of the present disclosure. System 100 of FIG. 1A includes network services 110A through 110F (collectively “network services 110”), models 121A through 121N (collectively “models 121”), various user devices, including user devices 109A and 109B (collectively “user devices 109”), and requesting system 111, all interconnected and capable of communicating over network 105. In some examples, each of models 121 may be considered to be operating in a live and/or production environment, providing supporting services to various systems within FIG. 1A, such as network services 110, user devices 109, and requesting system 111. Network 105 may represent any public or private communications network or other network, and in some examples, may be or may be part of the internet.

In some examples, each of network services 110 may be operated or controlled by a single entity (e.g., a commercial bank). In another example, however, one or more of network services 110 may be operated by any number of independent entities. In general, each network service 110 may perform any of a variety of services, and accordingly, may be a commercial website (e.g., online retailer, product fulfillment service, online shopping hub), a network service operated by a financial institution (e.g., credit card or loan processor, credit service bureau or assessment resource, banking website, information service or financial information aggregator, broker), an advertising network, a network infrastructure device (e.g., router or switch), or other system that may perform a service on network 105. In some examples, one or more network services 110 (or requesting system 111) may use services provided by one or more production systems 194, as further described below. Alternatively, or in addition, one or more production systems 194 may be capable of modifying the operation of such network services 110 or requesting system 111.

FIG. 1A also illustrates consumption framework 140 in communication with each of models 121 over network 106. Consumption framework 140 may have multiple capabilities, where each such capability may be enabled or configured to operate based on configuration settings 153. For example, configuration settings 153 may be used to enable or disable certain capabilities of consumption framework 140 for different situations or contexts.

Consumption framework 140 includes data capture platform 151, which may receive model output data 102 from one or more models 121. Data capture platform 151 includes data store 152, which may be a low-latency data store, capable of storing model output data 102 streamed in near-real time from models 121. Network 106 may be a private network providing each of models 121 with access to consumption framework 140, which may be appropriate when consumption framework 140 operates within an enterprise network or private data center. Although illustrated separately from network 105, network 106 may, however, represent any public or private communications network or other network, and in some examples, may be or may be part of the internet, and/or may be part of network 105.

Data capture platform 151 is configured to output data, such as a stream or sequence of model output data 102, to various processing platforms within consumption framework 140. Alternatively, or in addition, data capture platform 151 may be configured to provide access, to each of such processing platforms, to model output data 102 stored within data store 152.

In some examples, each processing platform represents a relatively independent capability of consumption framework 140. As illustrated in FIG. 1A, such platforms include monitoring platform 161, analytics platform 162, health platform 163, and balancing platform 164. Each of these platforms may communicate, control, and/or interact with other systems within system 100, including model retraining infrastructure 191, business unit computing systems 192, model remediation infrastructure 193, and production systems 194A through 194D (collectively “production systems 194”). In some examples, monitoring platform 161 may output monitoring data 171A to one or more of business unit computing systems 192, and monitoring data 171B to model retraining infrastructure 191. Similarly, analytics platform 162 may output analytics reports 172 to one or more of business unit computing systems 192, health platform 163 may output health data 173 to model remediation infrastructure 193, and balancing platform 164 may output load balancing data 174 to one or more of production systems 194.

Any of model retraining infrastructure 191, business unit computing systems 192, model remediation infrastructure 193, and production systems 194 may be considered, relative to consumption framework 140, to be a downstream system capable of performing further operations within the context of a broader system. In some examples, consumption framework 140 may be capable of controlling, adjusting, and/or affecting how some or all aspects of how such downstream systems operate. Further, in some cases, particularly where one or more of network services 110 and/or requesting system 111 may be part of business unit computing systems 192 or production systems 194 (or other systems), one or more of network services 110 and/or requesting system 111 may also be considered a downstream system capable of being controlled by consumption framework 140. Further, although systems 191, 192, 193, and 194 are illustrated separately from consumption framework 140 in FIG. 1A, other implementations are considered within the scope of the present disclosure. For example, one or more of model retraining infrastructure 191, business unit computing systems 192, model remediation infrastructure 193, and production systems 194 may be integrated into and/or may be a component of consumption framework 140.

For ease of illustration, only a limited number of network services 110, requesting systems 111, user devices 109, networks 105 and 106, models 121, consumption frameworks 140, model retraining infrastructures 191, business unit computing systems 192, model remediation infrastructures 193, production system 194, and others are shown in FIG. 1A. However, techniques in accordance with one or more aspects of the present disclosure may be performed with any number of such devices, networks, frameworks, and systems. Such systems may be implemented through any suitable computing system or processing system, such as one or more servers, cloud computing systems, mainframes, or other systems. In some examples, such systems may represent or be implemented through one or more virtualized compute instances (e.g., virtual machines, containers) of a data center, cloud computing system, server farm, and/or server cluster. In these or examples, such systems may be accessible over a network as a web service, website, or other service platform.

Some of the operations involving network 105 illustrated and/or described in connection with FIG. 1A may represent conventional activities or interactions between user devices 109, network services 110 over network 105. For example, some of the operations between user devices 109 and network services 110 over network 105 may represent operations pertaining to ecommerce, online shopping, communication, credit or payment processing, information retrieval, and other tasks typical of those that may involve network 105. In one example, network service 110A may be an online retailer, and network service 110F may be a credit card processor that processes payment. In such an example, network service 110F may collect information about a transaction or set of transactions. Network service 110F may evaluate the information to determine whether fraud is occurring. To make such an assessment, network service 110F outputs, over network 105, model input data 101, which may include information sufficient to enable one or more of models 121 to determine the likelihood that fraud is occurring. One or more of models 121 process model input data 101 and generate a prediction. The one or more models 121 output the prediction over network 105, where the prediction may be included in model output data 102. Network service 110F receives the prediction and uses it to identify whether one of models 121 has determined that fraud is occurring. Based on the prediction, network service 110F may take action, such as by denying a credit card transaction, or alternatively, enabling the transaction to proceed.

Other devices connected to network 105 may also interact with and/or use models 121. For example, one or more user devices 109, such as user device 109A, may interact with models 121 directly by outputting, over network 105, model input data 101. In one example, model input data 101 might include information about a user and/or that user's interests, and user device 109A may seek to use one of models 121 to select a movie or other content, or to select an advertisement to include in a web page presented in a user interface at user device 109A. In such an example, one or more models 121 receive the model input data 101, and in response, transmit model output data 102 over network 105 to user device 109A. User device 109A uses model output data 102 in an appropriate manner, which may involve presenting a user interface with a suggested movie or other content or presenting a web page with a selected advertisement.

In addition, one or more requesting systems 111 may also seek to use one or more models 121, and such uses might not necessarily be derived from activities of one specific user (e.g., as might be the case with fraud detection, content selection, or serving a targeted advertisement). Accordingly, requesting system 111 may be similar to one or more of network services 110, but may represent a network service or other system that operates relatively independently, meaning not primarily based on input received from a user or administrator. For example, requesting system 111 may use one or more models 121 to obtain predictions about the health of a network or a computing device, to obtain predictions about network traffic, or to obtain recommendations about how to improve the operation of the network, a computing device, or other system. In such examples, requesting system 111 outputs model input data 101 over network 105 to a given model 121, and in response, that model 121 outputs model output data 102, which may include predictions based on the model input data 101. Requesting system 111 may act on the predictions, such as by adjusting how traffic is routed on network 105 or otherwise modifying operations of system 100 under the control of requesting system 111.

In accordance with one or more aspects of the present disclosure, one or more models 121 may output model output data 102 to consumption framework 140. In other words, and as described above, when models 121 are presented with model input data 101 from various requesting systems within system 100 (e.g., network services 110, user devices 109, and/or requesting systems 111), those models 121 respond to the requesting systems (user devices 109, network services 110, requesting system 111) with model output data 102. In addition, however, models 121 in FIG. 1A also stream model output data 102 to consumption framework 140 for processing. In such an example, a sequence of model output data 102 is contemporaneously streamed to consumption framework 140 as models 121 make predictions and/or perform other operations. The sequence of model output data 102 may include information about multiple predictions made by a given model 121, and in some cases, may include information about multiple predictions made by each of a plurality of models 121. Streaming of the sequence of model output data 102 may take place in near-real time or seemingly-near real time as predictions are made by the models 121, so that consumption framework 140 may correspondingly process the sequence of model output data 102 in near-real time or seemingly-near real time.

Although FIG. 1A illustrates models 121 sending model output data 102 to both requesting systems (e.g., user devices 109, network services 110, requesting system 111) and consumption framework 140, the model output data 102 sent to requesting systems and consumption framework 140 might not necessarily be the same. In some examples, model output data 102 sent to consumption framework 140 may include additional information (e.g., metadata, information about model inputs, model execution times, model operation, timestamps, and other information) that might not be included in the model output data 102 sent to the requesting systems. In general, model output data 102 sent to consumption framework 140 may include additional information that may be useful for processing performed by consumption framework 140. In some cases, that additional information might not be needed for the purposes of a system (e.g., user devices 109, network services 110) that merely seeks to use one or more of models 121 to generate a prediction. In other examples, however, certain information that might be included in model output data 102 sent to the requesting system might not be included within model output data 102 sent to consumption framework 140.

In operation, and in an example that can be described in the context of FIG. 1A, data capture platform 151 of consumption framework 140 receives streaming model output data 102 from each of models 121 (or from a system that manages models 121, such as a model library). For instance, the streaming model output data 102 received by consumption framework 140 may reflect a series of operations performed by models 121, typically as driven by various requests that models 121 receive over network 105 from requesting devices (user devices 109, network services 110, and requesting system 111). As those models 121 process model input data 101 and generate a prediction, the models 121 output the prediction to the requesting devices over network 105, and in some examples, simultaneously stream a corresponding stream of model output data 102 over network 106 to consumption framework 140.

Consumption framework 140 stores the streamed model output data 102 and prepares to process the model output data 102. For instance, in FIG. 1A, data capture platform 151 stores the streamed model output data 102 in data store 152. Consumption framework 140 evaluates configuration settings 153 to determine the type or types of operations to perform on model output data 102. Consumption framework 140 may apply each of platforms 161, 162, 163, and 164 to the sequence of model output data 102. Depending on the context, however, the processes and/or capabilities of each of platforms 161, 162, 163, and 164 might not be needed. Consumption framework 140 may therefore selectively apply only a subset of platforms 161, 162, 163, and/or 164 to the model output data 102. Consumption framework 140 uses configuration settings 153 to identify the type or types of processing that should be performed on model output data 102, and then performs the selected processing on model output data 102.

For instance, monitoring platform 161 of consumption framework 140 may monitor the accuracy of one or more of models 121. In one example, monitoring platform 161 evaluates model output data 102 and determines that the accuracy of model 121A has degraded over time. In response, monitoring platform 161 outputs monitoring data 171A to one or more business unit computing systems 192, where the monitoring data 171A may take the form of an alert about degrading accuracy of model 121A. In some examples, the business unit computing systems 192 receiving the alert 171A are those associated with businesses or business units that use model 121A in business operations. In response, one or more of business unit computing systems 192 present monitoring data 171A in a user interface at a computing device (not specifically shown in FIG. 1A) that is operated by an administrator or relevant personnel. Such an administrator may cause model retraining infrastructure 191 to retrain or otherwise modify model 121A to address the accuracy degradation.

Alternatively, or in addition, and in response to determining that model 121A accuracy has degraded over time, monitoring platform 161 outputs monitoring data 171B to model retraining infrastructure 191. Model retraining infrastructure 191 receives monitoring data 171B and determines that the data includes instructions to retrain or otherwise modify model 121A. Accordingly, in this example, monitoring platform 161 may retrain and/or update model 121A independently, without requiring guidance or input from an administrator or other human user.

Analytics platform 162 of consumption framework 140 may perform analytics on model output data 102. For instance, and as an example, analytics platform 162 evaluates model output data 102 and generates one or more business intelligence reports, which may be based on model input data 101, model output data 102, and/or operations being performed by any of models 121. Analytics platform 162 outputs analytics reports 172 over a network to one or more business unit computing systems 192 for evaluation. In some examples, a business unit computing system 192 may, based on the analytics reports 172, interact with one or more production systems 194, causing such production systems 194 to modify or change their operation. Causing changes to the operation of production systems 194 may lead to one or more of network services 110 or requesting system 111 also operating differently, at least to the extent that network services 110 or requesting system 111 employ processes or services of, or are otherwise affected by operations of, production systems 194 (see dotted arrow in FIG. 1A extending between production systems 194 and network services 110 and requesting system 111, which is intended to indicate interaction and/or control between such systems).

Health platform 163 of consumption framework 140 may assess the health of one or more models 121. For instance, and as an example, health platform 163 evaluates model output data 102 and determines that for one or more models 121, the model may be making accurate predictions, but is nevertheless not operating correctly. For example, one of models 121 might not be generating predictions within an acceptable timeframe or within timeliness parameters of a service level agreement that may apply to that model. In such an example, health platform 163 outputs health data 173 to model remediation infrastructure 193. Model remediation infrastructure 193 evaluates health data 173 and determines that it includes instructions for remediating the affected model or models 121. Model remediation infrastructure 193 outputs signals over a network (e.g., network 106 or a network not specifically shown in FIG. 1A) and performs remediation operations on one or more of models 121, which may have the effect of bringing the performance of such models in line with applicable service level agreements.

Balancing platform 164 of consumption framework 140 may use model output data 102 to scale up, scale down, or load balance resources used by one or more production systems 194. For instance, and as an example, balancing platform 164 evaluates a sequence of model output data 102 and determines, based on predictions made by one or more models 121, current or future infrastructure needs for one or more of production systems 194. Balancing platform 164 makes this determination using the predictions made by one or more of model 121, where those predictions may be included and/or reflected within model output data 102 received by consumption framework 140. Balancing platform 164 outputs load balancing data 174 to at least some of production systems 194. In some examples, each instance of load balancing data 174 may represent a control signal that causes infrastructure allocated to production systems 194 to be scaled up or down. For example, as illustrated in FIG. 1A, balancing platform 164 may output, to production system 194A, load balancing data 174A representing signals or instructions that cause appropriate infrastructure scaling to be applied to production system 194A. Similarly, balancing platform 164 may output, to production system 194B, load balancing data 174B representing signals or instructions that cause appropriate infrastructure scaling to be applied to production system 194B. Balancing platform 164 may also output load balancing data 174C and 174D to production systems 194C and 194D, respectively, for load balancing or scaling purposes.

FIG. 1B is a conceptual diagram illustrating an example flow diagram of how model outputs generated by an artificial intelligence model may be used, in accordance with one or more aspects of the present disclosure. As illustrated in FIG. 1B, model outputs are received by a real time (or near-real time) event processing process, which may correspond to or be implemented by the data capture platform 151 illustrated and described in connection with FIG. 1A. The event processing platform process stores data in a low-latency data store that enables real time processing of a sequence of model outputs, or at least near-real time or seemingly-near real time processing of such outputs.

Model output data processed by the data capture process 151 can feed model output data 102 to any or all of a number of other processes illustrated in FIG. 1B. These processes include a model prediction accuracy monitoring process (which may correspond to monitoring platform 161 of FIG. 1A), a real time prediction analytics process (which may correspond to analytics platform 162 of FIG. 1A), a model performance health check process (which may correspond to health platform 163 of FIG. 1A), and a system load balancing process (which may correspond to balancing platform 164 of FIG. 1A).

In FIG. 1B, the model prediction accuracy process may generate accuracy alerts (e.g., monitoring data 171A as described in FIG. 1A) and/or retraining instructions (e.g., monitoring data 171B as described in FIG. 1A). In some examples, the alerts, retraining instructions, and/or other information generated by the model prediction accuracy process may be validated, such as through statistical processes to help ensure model accuracy assessments are themselves accurate.

As also illustrated in FIG. 1B, the real time prediction analytics process may generate reports, which may correspond to business intelligence reports or analytics reports 172 described in connection with FIG. 1A. The model performance health check process may generate both health reports and health alerts (e.g., health data 173 in FIG. 1A). And the system load balancing process may generate scaling instructions (e.g., load balancing data 174). Such scaling instructions may be based on predictions reported within model output data 102, and may be used for automatic scaling of infrastructure associated with production systems 194.

Techniques described herein may provide certain technical advantages. For instance, by monitoring model accuracy, consumption framework 140 may enable early and timely interventions where prediction accuracy for one or more models 121 begins to decline. As a result, consumption framework 140 is able to ensure each of models 121 continue to make accurate predictions and perform in a relatively stable manner.

By performing predictive analytics on model output data 102, particularly based on a sequence of near-real time or seemingly-near real time model output data 102, consumption framework 140 may provide timely insights about predictions made by models 121, about operations by one or more models 121, or about the overall operation of a system that uses the models 121. Such analytics may also and reveal insights across multiple models 121 that might not otherwise be apparent when analytics are performed based merely on the outputs of only one or a small number of models.

Also, by performing model performance health checks, particularly across a sequence of model output data 102 collected over a period of time, consumption framework 140 may identify problems with one or more models 121 that might not be otherwise apparent though assessments of the accuracy of the predictions made by a model or through assessments based on a single prediction or a limited period of time. For example, health assessments for model 121 may identify performance, timeliness, and/or resource consumption issues with models 121 that may negatively affect other systems. Consumption framework 140 may initiate processes to correct such issues and improve the operation of the system as a whole.

Still further, by performing load balancing operations based on predictions made by models 121 (as reflected in a sequence of model output data 102), load balancing operations may be timelier and more effective. In particular, load balancing and automatic scaling based on near-real time data or seemingly-near real time data is likely to be significantly more effective than load balancing operations that are based on historical data.

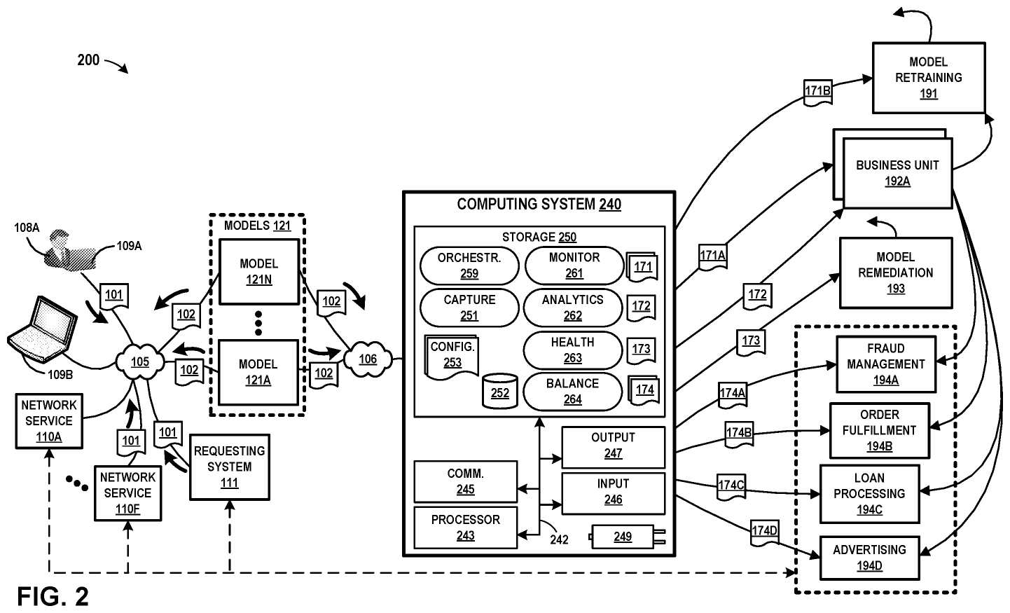

FIG. 2 is a block diagram illustrating an example system for processing outputs generated by one or more models, in accordance with one or more aspects of the present disclosure. FIG. 2 illustrates computing system 240 deployed within system 200 in a manner similar to how consumption framework 140 is deployed within system 100 in FIG. 1A. Computing system 240 may be considered an example or alternative implementation of consumption framework 140 of FIG. 1A. System 200 of FIG. 2 is therefore illustrated in a manner similar to system 100 of FIG. 1A, and includes many of the same elements shown in FIG. 1A. Elements included in FIG. 2 may correspond to earlier-described elements of FIG. 1A sharing the same reference numeral.

Computing system 240 is illustrated in FIG. 2 to facilitate a description of certain components, modules, and other aspects of a computing system that may implement a model outputs consumption framework, such as consumption framework 140 of FIG. 1A. Computing system 240 is also illustrated in FIG. 2 to facilitate a description of how such a computing system may operate in accordance with techniques described herein. Although computing system 240 of FIG. 2 may be considered an example implementation of consumption framework 140 of FIG. 1A, other implementations of consumption framework 140 are possible.

For ease of illustration, computing system 240 is depicted in FIG. 2 as a single computing system. However, in other examples, computing system 240 may be implemented through multiple devices or computing systems distributed across a data center, multiple data centers, or multiple cloud networks. For example, separate computing systems may implement functionality described herein as being performed by each of capture module 251, monitoring module 261, analytics module 262, health module 263, and balancing module 264 of computing system 240. Alternatively, or in addition, modules shown in FIG. 2 as included within computing system 240 may be implemented through distributed virtualized compute instances (e.g., virtual machines, containers) of a data center, cloud computing system, server farm, and/or server cluster.

In FIG. 2, computing system 240 is shown with underlying physical hardware that includes power source 249, one or more processors 243, one or more communication units 245, one or more input devices 246, one or more output devices 247, and one or more storage devices 250. Storage devices 250 may include capture module 251, monitoring module 261, health module 263, health module 263, balancing module 264, configuration data 253, and data store 252. One or more of the devices, modules, storage areas, or other components of computing system 240 may be interconnected to enable inter-component communications (physically, communicatively, and/or operatively). In some examples, such connectivity may be provided by through communication channels, which may include a system bus (e.g., communication channel 242), a network connection, an inter-process communication data structure, or any other method for communicating data.

Power source 249 of computing system 240 may provide power to one or more components of computing system 240. Power source 249 may receive power from the primary alternating current (AC) power supply in a building, data center, or other location. In some examples, power source 249 may include a battery or a device that supplies direct current (DC). Power source 249 may have intelligent power management or consumption capabilities, and such features may be controlled, accessed, or adjusted by processors 243 to intelligently consume, allocate, supply, or otherwise manage power.

One or more processors 243 of computing system 240 may implement functionality and/or execute instructions associated with computing system 240 or associated with one or more modules illustrated herein and/or described herein. One or more processors 243 may be, may be part of, and/or may include processing circuitry that performs operations in accordance with one or more aspects of the present disclosure.

One or more communication units 245 of computing system 240 may communicate with devices external to computing system 240 by transmitting and/or receiving data, and may operate, in some respects, as both an input device and an output device. In some or all cases, one or more communication units 245 may communicate with other devices or computing systems over a network, such as, but not limited to, network 106.

One or more input devices 246 may represent any input devices of computing system 240, and one or more output devices 247 may represent any output devices of computing system 240. Input devices 246 and/or output devices 247 may generate, receive, and/or process output from any type of device capable of outputting information to a human or machine. For example, one or more input devices 246 may generate, receive, and/or process input in the form of electrical, physical, audio, image, and/or visual input (e.g., peripheral device, keyboard, microphone, camera). Correspondingly, one or more output devices 247 may generate, receive, and/or process output in the form of electrical and/or physical output (e.g., peripheral device, actuator).

One or more storage devices 250 within computing system 240 may store information for processing during operation of computing system 240. Storage devices 250 may store program instructions and/or data associated with one or more of the modules described in accordance with one or more aspects of this disclosure. One or more processors 243 and one or more storage devices 250 may provide an operating environment or platform for such modules, which may be implemented as software, but may in some examples include any combination of hardware, firmware, and software. One or more processors 243 may execute instructions and one or more storage devices 250 may store instructions and/or data of one or more modules. The combination of processors 243 and storage devices 250 may retrieve, store, and/or execute the instructions and/or data of one or more applications, modules, or software. Processors 243 and/or storage devices 250 may also be operably coupled to one or more other software and/or hardware components, including, but not limited to, one or more of the components of computing system 240 and/or one or more devices or systems illustrated or described as being connected to computing system 240.

Capture module 251 may perform functions relating to capturing data streamed from models 121 as operations are being performed by model 121. In some examples, capture module 251 may be implemented as a distributed event store and stream processing platform that provides a unified, high-throughput, low latency platform for handling real time data feeds. In some examples, capture module 251 may be based on Apache Kafka.

Data store 252 of computing system 240 may represent any suitable data structure or storage medium for storing information relating to model output data 102, model input data 101, metadata associated with the operation of models 121, or other information that may be captured by capture module 251 of computing system 240. Data store 252 is preferably a low latency data store enabling real time, near-real time, or seemingly-near real time storage and access of data (e.g. model output data 102) captured from models 121 by capture module 251. The information stored in data store 252 may be searchable and/or categorized such that one or more modules within computing system 240 may provide an input requesting information from data store 252, and in response to the input, receive information stored within data store 252. Data store 252 may be primarily maintained by capture module 251.

Configuration data 253 may be stored within storage device 250 and/or data store 252 and may correspond to configuration settings 153 of FIG. 1A. In some examples, configuration data 253 may be used to change or direct operations of computing system 240 for various situations, contexts, businesses, or lines of businesses.

Monitoring module 261 may perform functions similar to those performed by monitoring platform 161 described in connection with FIG. 1A and/or relating to assessing model accuracy, such as described herein. Accordingly, monitoring module 261 may generate monitoring data 171 for processing by model retraining infrastructure 191 and/or business unit computing system 192A.

Analytics module 262 may perform functions similar to those performed by analytics platform 162 described in connection with FIG. 1A and/or relating to generating analytical reports. Such analytical reports (e.g., analytics reports 172) may be output to any of business unit computing systems 192 and may also form the basis for causing signals to be output to one or more production systems 194 to control the operation of such production systems 194.

Health module 263 may perform functions similar to those performed by health platform 163 as described in connection with FIG. 1A and/or relating to assessing the health of any of models 121, as distinct from assessing the accuracy of such models 121. Health module 263 may output health data 173, which may cause model remediation infrastructure 193 to perform remediation operations on one or more models 121.

Balancing module 264 may perform functions similar to those performed by balancing platform 164 as described in connection with FIG. 1A and/or relating to load balancing.

Balancing module 264 may perform load balancing by outputting signals, such as load balancing data 174, to one or more of production systems 194. Although primarily described in terms of load balancing of production systems 194, balancing module 264 may be capable of performing load balancing operations on other systems included within system 200, including computing system 240 or systems supporting network services 110.

Orchestration module 259 may perform functions relating to coordinating operations by computing system 240 generally, including relating to operations performed by each of capture module 251, monitoring module 261, analytics module 262, health module 263, and balancing module 264. For example, orchestration module 259 may coordinate distribution of data captured by capture module 251 to each of modules 261, 262, 263, and 264.

In operation, and in accordance with one or more aspects of the present disclosure, computing system 240 may receive model output data 102 streamed from one or more of models 121. For instance, in an example that can be described in the context of FIG. 2, one or more of models 121 transmit model output data 102 over network 106 to computing system 240.

Communication unit 245 of computing system 240 detects a signal and outputs information about the signal to capture module 251. Capture module 251 determines that the signal includes model output data 102, corresponding to information about processing performed by one or more of models 121. The sequence of model output data 102 may include information about multiple predictions made by one or more of models 121, including which of models 121 was used, the inputs to the model that were used, predictions generated, responses and/or other outputs generated by the model, metadata associated with the operation of the model, information about execution time and/or resources consumed by the model, and other information that may pertain to how any of models 121 may be operating. Often, model output data 102 is received by computing system 240 soon after the relevant model is applied to model input data 101 and/or soon after the model performs predictive operations. In some cases, such model output data 102 is received as a sequence of model output data 102, where each instance in the sequence includes information about a prediction made by or an operation performed by one of the models 121. Each instance of model output data 102 may be received by computing system 240 in near-real time or seemingly-near real time, thereby enabling timely processing and analysis of model output data 102 by computing system 240.

Computing system 240 may store the sequence of model output data 102. For instance, again with reference to the example being described, capture module 251 forwards model output data 102 and/or information about model output data 102 to data store 252. Data store 252 stores the data and/or information and makes it available, on a low-latency basis, to other modules within computing system 240 (e.g., monitoring module 261, analytics module 262, health module 263, balancing module 264).

Computing system 240 may access data that is used to select operations to be performed on model output data 102. For instance, still continuing with the example being described with reference to FIG. 2, capture module 251 accesses configuration data 253 within storage device 250. In some examples, configuration data 253 may include information about the types of operations that can or should be performed on model output data 102 streamed from models 121. In some examples, configuration data 253 may be generated by one or more business unit computing systems 192 or entities that use and/or rely on one specific model 121 (or a subset of such models 121) that process model input data 101. Accordingly, there may be configuration data 253 associated with and for use by each business unit seeking to use computing system 240 for processing model output data 102. Alternatively, or in addition, there may be specific configuration data 253 associated with and/or applicable to model output data 102 generated by each different model 121.

Computing system 240 may configure operations to be performed on model output data 102 based on configuration data 253. For instance, again with reference to FIG. 2, orchestration module 259 determines, based on a given set of configuration data 253, the specific operations that computing system 240 may perform on model output data 102 received from model 121. In some examples, computing system 240 may perform all available operations on model output data 102. In other examples, computing system 240 may perform only selected operations on model output data 102. For example, orchestration module 259 of computing system 240 may, for a given set of model output data 102, enable monitoring module 261 to perform just model prediction accuracy monitoring through monitoring module 261. In another example, orchestration module 259 of computing system 240 may, for a different set of model output data 102, enable just analytics module 262 to perform analytics on model output data 102. Similarly, orchestration module 259 of computing system 240 may selectively enable health module 263 for performing health assessments using model output data 102 or balancing module 264 for performing load balancing tasks. In general, based on configuration data 253, computing system 240 may perform any or all of a set of available processes provided by computing system 240.

Monitoring module 261 of computing system 240 may monitor accuracy of model 121A. For instance, again to the example being described with reference to FIG. 2, orchestration module 259 determines, based on configuration data 253, that model monitoring operations should be performed based on a sequence of model output data 102 received from one of the models 121, such as model 121A. Orchestration module 259 enables monitoring module 261 to access at least some of model output data 102 within data store 252. Where data store 252 is a low latency data store, monitoring module 261 is able to access model output data 102 from data store 252 very quickly. Monitoring module 261 evaluates the accessed model output data 102 and evaluates the accuracy of model 121A based on the accessed model output data 102. Monitoring module 261 generates an assessment of the accuracy of model 121A.

Monitoring module 261 of computing system 240 may output one or more alerts based on the generated assessment of the accuracy of model 121A. For instance, continuing with the example, monitoring module 261 of computing system 240 causes communication unit 245 to output monitoring data 171A over a network (network not specifically shown in FIG. 2) to one or more of business unit computing systems 192. One or more of business unit computing systems 192, such as business unit computing system 192A, receives monitoring data 171A and determines that monitoring data 171A corresponds to an alert about model 121A. Business unit computing system 192A may also determine that monitoring data 171A includes information about an assessment of the accuracy of model 121A. Business unit computing system 192A routes information to a computing device operated by an administrator, data scientist, or other personnel associated with the business or business unit that controls business unit computing system 192A. One or more of such computing devices, operated by relevant personnel, may use the information to generate a user interface to present information about the accuracy of model 121A.

Monitoring module 261 of computing system 240 may also initiate a retraining cycle. For instance, still continuing with the example being described, monitoring module 261 determines, based on its assessment of model accuracy, that model 121A should be retrained. Monitoring module 261 outputs monitoring data 171B to model retraining infrastructure 191. Model retraining infrastructure 191 receives the monitoring data 171B and determines that it includes instructions for retraining model 121A. In some cases, monitoring data 171B may include training data or information about available training data that can be used to retrain model 121A. Model retraining infrastructure 191 retrains model 121A using the new or modified training data and/or otherwise interacts with model 121A to update and/or retrain model 121A (see arrow originating from model retraining infrastructure 191, intended to represent interaction and/or retraining of one or more models 121).

To initiate a retraining cycle, monitoring module 261 may act independently based on model prediction assessments performed by computing system 240. For instance, in some cases, monitoring module 261 may evaluate thresholds associated with model predictions and/or model output data 102. For example, monitoring module 261 may access, establish, or determine appropriate distributions for model outputs (or for features). In another example, monitoring module 261 may perform feature-to-response distribution monitoring and use such analysis to determine whether model accuracy is changing, degrading, and/or remaining stable. In some situations, such distributions or other information may be received by monitoring module 261 from one or more of business unit computing systems 192, based on analysis performed by such systems or personnel associated with a corresponding business unit. Where monitoring module 261 determines, based on a sequence of model output data 102 received by capture module 251, that the actual model output data 102 is inconsistent with the appropriate distributions for model 121A, monitoring module 261 may determine that the accuracy of model 121A is degrading or is otherwise inadequate. Based on such a determination, monitoring module 261 causes computing system 240 to initiate a retraining cycle by outputting signals to control model retraining infrastructure 191.

To initiate a retraining cycle, monitoring module 261 may alternatively rely on input from a data scientist. For instance, in some cases, monitoring module 261 may output monitoring data 171B to one or more business unit computing systems 192. One or more business unit computing systems 192 process and/or prepare data for evaluation by a data scientist, and include such data in a user interface presented at a computing device operated by the data scientist. The computing device operated by the data scientist may detect input reflecting an evaluation by the data scientist of prepared data, model input data 101, and corresponding model output data 102. The computing device may output information about the evaluation to one or more business unit computing systems 192. One or more of business unit computing systems 192, such as business unit computing system 192A, may use the data to generate new or updated training data. Business unit computing system 192A outputs instructions along with the new or updated training data to model retraining infrastructure 191. Model retraining infrastructure 191 causes model 121A to be retrained based on the new or updated training data and/or causes model 121A to be replaced by an updated model 121A based on the retraining.

Analytics module 262 of computing system 240 may perform analytical operations using model output data 102. For instance, still with reference to FIG. 2, orchestration module 259 determines, based on configuration data 253 that analytical operations of a specified type should be performed based on a sequence of model output data 102. Orchestration module 259 enables analytics module 262 to access model output data 102 within data store 252. Analytics module 262 uses model output data 102 to perform analytics, which may be near-real time analytics if based on sufficiently timely model output data 102.

Analytics module 262 may output data about analytics performed. For instance, again continuing with the example in the context of FIG. 2, analytics module 262 generates one or more analytics reports 172, which may take the form of near-real time or seemingly-near real time business intelligence reports. Analytics module 262 causes communication unit 245 to output one or more analytics reports 172 to one or more business unit computing systems 192.

In some cases, analytics reports 172 may include information about transactions involving user devices 109 and various network services 110, where such transactions may be product or service purchases or other interactions between user devices 109 (each operated by a user 108) and computing systems supporting network services 110. In other examples, such analytics reports 172 may include information about interactions involving one or more of network services 110, which may include how long a given user 108 was logged in to a specific system associated with a network service 110 or what types of activities that user 108 performed. Analytics reports 172 may also include information about what information types or advertisements have been presented to the user through a user device 109, and how the user responded (e.g., purchased a product or service, added a product to a shopping cart). Where model output data 102 is tagged with timestamp or temporal information, analytics module 262 may generate analytics reports 172 that include information about activities occurring during certain time frames. For example, analytics reports 172 may report on activities occurring within a specific one-hour period or on specific days (e.g., summarizing activities that tend to take place on Fridays). Also, since model output data 102 is streamed to computing system 240 as models 121 are operating, analytics module 262 may be capable of generating analytics reports 172 reflecting the most recent data (e.g., reporting on activities occurring during the current day, or even during the most recent minute or shorter time frame).

In some cases, analytics reports 172 may enable one or more systems controlled by one or more of business unit computing systems 192 to act on the reports. For example, business unit computing system 192A may determine that an analytics report 172 that it receives indicates that fraud may be occurring. Such fraud may involve a network service 110 that is operated by the business associated with business unit computing system 192A. In such an example, business unit computing system 192A may output signals to one or more production systems 194, such as production system 194A, which may be equipped to deal with fraud management tasks. In such an example, business unit computing system 192A may control production system 194A and thereby cause production system 194A to take actions and perform operations that prevent, mitigate, investigate, or otherwise deal with fraud that may be taking place (see arrow from business unit computing systems 192 to production system 194A, indicating control of production system 194A by business unit computing system 192A). In some cases, such actions may additionally involve production system 194A interacting with one or more systems used by network services 110, user devices 109, network 105, network 106, or other systems.

In another example, an analytics report 172 received by business unit computing system 192A may indicate that inventory is running low on a specific product being sold at an online store operated by one of network services 110. In such an example, business unit computing system 192A interacts with production system production system 194B to cause production system 194B, which may be equipped to handle tasks relating to order fulfillment, to take action to remedy the low inventory condition (see arrow from business unit computing systems 192A to production system production system 194B, indicating control of production system 194B by business unit computing system 192A). In some examples, production system 194B may cause inventory to be increased or reallocated from other physical locations to enable the relevant network service 110 to continue fulfilling online or physical orders in a timely manner.

Alternatively, or in addition, business unit computing system 192A may receive an analytics report 172 indicating that loan processing requests received by one or more of network services 110 have increased substantially. In such an example, business unit computing system 192A may interact with production system 194C, which may be capable of evaluating loan exposure by a bank or manage lending risk, to adjust the standards and/or criteria by which the relevant network service 110 approves loans to businesses or consumers. Accordingly, production system 194C may reconfigure or otherwise modify the operation of the relevant network service 110 to ensure that loan exposure or lending risk for a bank (or line of business) associated with business unit computing system 192A is reduced (or increased) appropriately.

Alternatively, or in addition, business unit computing system 192A may receive an analytics report 172 indicating that users operating certain user devices 109 may be receptive to advertisements for a certain type of product. In such an example, business unit computing system 192A may interact with production system 194D, which may be a system operated by an advertising network. Production system 194D may interact with one or more of network services 110 to ensure that appropriate advertisements are presented to the relevant user devices 109.

In other examples, one or more of business unit computing systems 192 may interact with, control, or otherwise modify the operation of other systems based on information included within analytics reports 172. Such information may be used to predict future events (future purchases, loan demand, fraud occurrences, consumer interests) that may affect operation of business unit computing systems 192, production systems 194, and/or network services 110.

Health module 263 of computing system 240 may assess the health of one more of models 121. For instance, referring again to an example in the context of FIG. 2, orchestration module 259 determines, based on configuration data 253 that the health of one or more models 121 should be evaluated using model output data 102. Orchestration module 259 enables health module 263 to access model output data 102 within data store 252. Health module 263 uses the accessed model output data 102 to assess the performance and/or health of one or more of models 121. Where model output data 102 is real time data, near-real time data, or seemingly-near real time data, health module 263 may be able to generate up-to-the-moment health reports.

Health module 263 may output health data 173 to one or more relevant business unit computing systems 192. In such an example, the received health data 173 may be routed by the relevant business unit computing system 192 to computing devices operated by an administrator other business (or line of business) personnel.

Alternatively, or in addition, health module 263 may output health data 173 to model remediation infrastructure 193. Model remediation infrastructure 193 may evaluate health data 173 and determine, based on the information included within such health data 173, that remediation or modification of one or more models 121 is appropriate. In some examples, health data 173 may provide information about model scoring execution times, peak request times, and other information providing indicia of the health of one or more models 121. Model remediation infrastructure 193 may interact with one or more of models 121 to retrain, modify, correct, or otherwise take actions to improve the health of one or more of models 121.

In some examples, model remediation infrastructure 193 may be able to identify, based on health data 173, problems with the operation of a given model 121 that might not be apparent from other data, such as monitoring data 171 generated by analytics module 262. For instance, health data 173 generated by health module 263 may indicate that while model 121A may seem to be making predictions accurately, the amount of time that model 121A takes to make a prediction has increased, which may deteriorate the quality of the services provided to user devices 109 by one or more network services 110 that rely on model 121A. In such an example, model remediation infrastructure 193 may use health data 173 to identify the problem and/or investigate the source of the problem. Model remediation infrastructure 193 may determine that users have started to provide more input data when presented with various prompts by a given network service 110. As a result of the additional input, model 121A may be taking longer to process the input, thereby delaying the prediction or response generated by model 121A in response to the input. Model remediation infrastructure 193 may take actions to rectify the issue and/or modify model 121A to improve the responsiveness of the model. For example, model remediation infrastructure 193 may interact with model 121A or systems supporting model 121A to allocate more resources to processing input for model 121A, and thereby improve the operation of model 121A (see arrow originating from model remediation infrastructure 193, intended to represent interaction and/or remediation of one or more models 121 or network services 110).

Balancing module 264 of computing system 240 may perform load balancing operations. For instance, again referring to FIG. 2, orchestration module 259 determines, based on configuration data 253, that various load balancing operations should be performed using model output data 102. Orchestration module 259 enables balancing module 264 to access model output data 102 within data store 252. Balancing module 264 uses model output data 102 to evaluate whether one or more production systems 194 are experiencing high resource utilization or, based on predictions of future behavior, will be experiencing high resource utilization at some point in the future.

Accordingly, to the extent that model output data 102 is real time data, near-real time data, or seemingly-near real time data, balancing module 264 can make assessments about current resource usage, rather than assessments that may be based on stale or historical data. Balancing module 264 may act on such assessments by scaling up resources allocated to any of production systems 194, scaling down resources allocated to any of production systems 194, and/or otherwise balancing resources due to needs, importance, criticality, and timeliness priorities. Balancing module 264 may also act on assessments about resources that are expected to be consumed in the future by one or more of production systems 194, based on predictions made by models 121 and included within the sequence of model output data 102 streamed to computing system 240. In such an example, balancing module 264 may act on predicted future needs by scaling up or preparing to scale up production systems 194 that are expected to experience high utilization in a future timeframe, while also scaling down or preparing to scale down production systems 194 that are expected to experience less utilization during that timeframe. Such scaling may be used to accommodate expected increases in product sales (e.g., handled by production system 194B) or fraud management activity (e.g., handled by production system 194A).

Balancing module 264 of computing system 240 may, in some cases, also perform load balancing for other systems. For instance, where the resources consumed by computing system 240 may significant (e.g., involving real time or near-real time processing and analysis of model output data 102), balancing module 264 may determine that allocating additional resources to computing system 240 is appropriate (e.g., allocating additional virtualized computing instances that compose computing system 240 or additional computing systems 240). In some examples, balancing module 264 may allocate additional resources to (or adjust the allocation of resources used by) capture module 251, monitoring module 261, analytics module 262, health module 263, and/or balancing module 264.

Modules illustrated in FIG. 2 (e.g., capture module 251, monitoring module 261, analytics module 262, health module 263, balancing module 264) and/or illustrated or described elsewhere in this disclosure may perform operations described using software, hardware, firmware, or a mixture of hardware, software, and firmware residing in and/or executing at one or more computing devices. For example, a computing device may execute one or more of such modules with multiple processors or multiple devices. A computing device may execute one or more of such modules as a virtual machine executing on underlying hardware. One or more of such modules may execute as one or more services of an operating system or computing platform. One or more of such modules may execute as one or more executable programs at an application layer of a computing platform. In other examples, functionality provided by a module could be implemented by a dedicated hardware device.

Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may interact with and/or operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated.

Further, each module, data store, component, program, executable, data item, functional unit, or other item illustrated within a storage device may be implemented in various ways. For example, each module, data store, component, program, executable, data item, functional unit, or other item illustrated within a storage device may be implemented as a downloadable or pre-installed application or “app.” In other examples, each module, data store, component, program, executable, data item, functional unit, or other item illustrated within a storage device may be implemented as part of an operating system executed on a computing device.

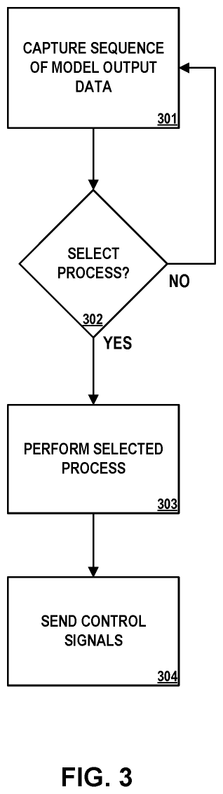

FIG. 3 is a flow diagram illustrating operations performed by an example consumption framework 140 in accordance with one or more aspects of the present disclosure. FIG. 3 is described below within the context of consumption framework 140 of FIG. 1A. In other examples, operations described in FIG. 3 may be performed by one or more other components, modules, systems, or devices. Further, in other examples, operations described in connection with FIG. 3 may be merged, performed in a difference sequence, omitted, or may encompass additional operations not specifically illustrated or described.

In the process illustrated in FIG. 3, and in accordance with one or more aspects of the present disclosure, consumption framework 140 may capture a sequence of model output data generated by a model (301). For example, network service 110A, which may be performing services on behalf of one or more user devices 109, transmits model input data 101 over network 105 to model 121A. Model 121A receives model input data 101, generates a prediction, and responds to network service 110A by sending the prediction over network 105. Model 121A also outputs model output data 102 over network 106 to consumption framework 140, where model output data 102 includes information about the prediction made by model 121A on behalf of network service 110A. Model 121A may continue to generate predictions in response to further requests (e.g., from network service 110A or other network services 110), and each time, model 121A responds to the requests by transmitting the prediction over network 105 to the requesting system and sends corresponding model output data 102 consumption framework 140. In some examples, various other models 121 also receive prediction requests (e.g., in the form of model input data 101) from various user devices 109 and network services 110. In response, models 121 respond to each of those requests by sending a prediction over network 105 to the appropriate requesting system. As models 121 generate such predictions, each of models 121 also output corresponding model output data 102 over network 106 to consumption framework 140. As a result, consumption framework 140 receives a sequence of model output data 102 from models 121 over network 106.

Consumption framework 140 may select a process to perform on the model output data 102 (302). For example, consumption framework 140 accesses configuration settings 153 and determines whether configuration settings 153 specify a process to perform on a given sequence of model output data 102. In one example, consumption framework 140 determines that configuration settings 153 indicate that one of the available processes, such as that provided by monitoring platform 161, should be performed on model output data 102. Consumption framework 140 enables the process provided by monitoring platform 161 to be performed (YES path from 302). If consumption framework 140 determines that configuration settings 153 do not indicate that one of the available processes should be performed, configuration framework 140 waits until the configuration settings 153 indicate that at least one process should be performed on captured sequence of streamed model output data 102 (NO path from 302).

Consumption framework 140 may perform the selected process based on at least a portion of the sequence of model output data (303). For example, monitoring platform 161 of consumption framework 140 accesses model output data 102 from data store 152. Monitoring platform 161 evaluates model output data 102 and determines that the predictive power of one of models 121, such as model 121A, has degraded over time. Monitoring platform 161 further determines a plan for retraining model 121A.

Consumption framework 140 may send control signals to control one or more downstream systems (304). Specifically, monitoring platform 161 may send control signals to the downstream system, instructing the apparatus to perform a specific operation. In one example, monitoring platform 161 outputs a series of signals to a downstream system, such as model retraining infrastructure 191. Model retraining infrastructure 191 receives the signals and determines that the signals include instructions for retraining model 121A. Model retraining infrastructure 191 interacts with model 121A to retrain model 121A. Accordingly, consumption framework 140 controls the operation of a downstream system (i.e., model retraining infrastructure 191) to cause model 121A to be retrained.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The disclosures of all publications, patents, and patent applications referred to herein are hereby incorporated by reference. To the extent that any material that is incorporated by reference conflicts with the present disclosure, the present disclosure shall control.

For ease of illustration, only a limited number of devices (e.g., user devices 109, network services 110, requesting systems 111, consumption frameworks 140, model retraining infrastructure 191, model remediation infrastructure 193, production systems 194, computing systems 240, as well as others) are shown within the Figures and/or in other illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The Figures included herein each illustrate at least one example implementation of an aspect of this disclosure. The scope of this disclosure is not, however, limited to such implementations. Accordingly, other example or alternative implementations of systems, methods or techniques described herein, beyond those illustrated in the Figures, may be appropriate in other instances. Such implementations may include a subset of the devices and/or components included in the Figures and/or may include additional devices and/or components not shown in the Figures.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced figures in order to avoid obscuring such concepts.

Accordingly, although one or more implementations of various systems, devices, and/or components may be described with reference to specific Figures, such systems, devices, and/or components may be implemented in a number of different ways. For instance, one or more devices illustrated herein as separate devices may alternatively be implemented as a single device; one or more components illustrated as separate components may alternatively be implemented as a single component. Also, in some examples, one or more devices illustrated in the Figures herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated in various Figures herein may alternatively be implemented as part of another device or component not shown in such Figures. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner. References herein to “real time” are intended to encompass near-real time or seemingly-near real time, such as from the perspective of a reasonable human observer.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, or optical disk storage, magnetic disk storage, or other magnetic storage devices, flash memory, or any other medium that can be used to store desired program code in the form of instructions or data structures and that can be accessed by a computer. Also, any connection may properly be termed a computer-readable medium. For example, if instructions are transmitted from a website, server, or other remote source using a wired (e.g., coaxial cable, fiber optic cable, twisted pair) or wireless (e.g., infrared, radio, and microwave) connection, then the wired or wireless connection is included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structure or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses, including, to the extent appropriate, a wireless handset, a mobile or non-mobile computing device, a wearable or non-wearable computing device, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

What is claimed is:

1. A method comprising:
capturing, by a computing system, a sequence of model output data generated by a model, wherein the sequence of model output data includes information about a plurality of predictions made by the model, and wherein each prediction in the plurality of predictions is generated by the model in response to a different set of model input data;
selecting, by the computing system and based on configuration settings, a process to perform on the sequence of model output data, wherein the process is selected from a plurality of available processes;
performing the selected process, by the computing system and based on at least a portion of the sequence of model output data, to generate information about performance of the model over time; and
sending, by the computing system and to a downstream system, control signals to modify operation of the downstream system based on the information about performance of the model over time.

2. The method of claim 1, wherein the model is a first model, wherein the model input data is first model input data, wherein the sequence of model output data is a sequence of first model output data, wherein the plurality of predictions is a first plurality of predictions, and wherein the method further comprises:
capturing, by the computing system, a sequence of second model output data generated by a second model, wherein the sequence of second model output data includes information about a second plurality of predictions made by the second model, wherein each prediction in the second plurality of predictions is generated by the second model in response to a different set of second model input data; and
performing the selected process, by the computing system and based on at least a portion of the sequence of second model output data, to generate information about performance of the second model over time.

3. The method of claim 2, wherein sending the control signals includes:
sending control signals to modify operation of the downstream system further based on the information about performance of the second model over time.

4. The method of claim 2, wherein the downstream system is a first downstream system, and wherein sending the control signals includes:
sending control signals to modify operation of a second downstream system based on the information about performance of the second model over time.

5. The method of claim 1, wherein the selected process includes assessing accuracy of the model, and wherein the method further comprises:
sending, by the computing system and to a business unit computing system, alerts about model inaccuracies.

6. The method of claim 1, wherein the selected process includes assessing accuracy of the model, and wherein sending the control signals includes:
sending control signals to model retraining infrastructure to cause the model retraining infrastructure to retrain the model.

7. The method of claim 1, wherein the selected process includes performing analytics on the model output data, wherein the method further comprises:
sending, by the computing system and to a business unit computing system, near-real time business intelligence reports.

8. The method of claim 1, wherein the selected process includes performing analytics on the model output data, and wherein sending the control signals includes:
sending control signals to a downstream computing system that responds to the control signals by modifying operation of a production system.

9. The method of claim 8, wherein sending control signals to the computing system further includes:
enabling the downstream computing system to cause the production system to change how the production system performs at least one of: monitoring for fraud, fulfilling online sales orders, processing loans, processing loan applications, or selecting an advertisement.

10. The method of claim 1, wherein the selected process includes monitoring health of the model, and wherein performing the selected process includes:
identifying an underperforming aspect of the model.

11. The method of claim 10, wherein sending the control signals includes:
sending control signals to model remediation infrastructure to cause the model remediation infrastructure to remediate the underperforming aspect of the model.

12. The method of claim 1, wherein the selected process includes performing load balancing of resources used by a production system, and wherein sending the control signals includes:
sending control signals to adjust, based on predictions made by the model, allocations of resources used by the production system.

13. The method of claim 1, wherein the selected process includes performing load balancing of resources used by the computing system, and wherein sending the control signals includes:
sending control signals to adjust, based on predictions made by the model, allocations of resources used by the computing system.

14. A computing system comprising processing circuitry and a storage device, wherein the processing circuitry has access to the storage device and is configured to:
capture a sequence of model output data generated by a model, wherein the sequence of model output data includes information about a plurality of predictions made by the model, and wherein each prediction in the plurality of predictions is generated by the model in response to a different set of model input data;
select, based on configuration settings, a process to perform on the sequence of model output data, wherein the process is selected from a plurality of available processes;
perform the selected process, based on at least a portion of the sequence of model output data, to generate information about performance of the model over time; and
send, to a downstream system, control signals to modify operation of the downstream system based on the information about performance of the model over time.

15. The computing system of claim 14, wherein the model is a first model, wherein the model input data is first model input data, wherein the sequence of model output data is a sequence of first model output data, wherein the plurality of predictions is a first plurality of predictions, and wherein the processing circuitry is further configured to:
capture a sequence of second model output data generated by a second model, wherein the sequence of second model output data includes information about a second plurality of predictions made by the second model, wherein each prediction in the second plurality of predictions is generated by the second model in response to a different set of second model input data; and
perform the selected process, based on at least a portion of the sequence of second model output data, to generate information about performance of the second model over time.

16. The computing system of claim 15, wherein to send the control signals, the processing circuitry is further configured to:
send control signals to modify operation of the downstream system further based on the information about performance of the second model over time.

17. The computing system of claim 15, wherein the downstream system is a first downstream system, and wherein to send the control signals, the processing circuitry is further configured to:
send control signals to modify operation of a second downstream system based on the information about performance of the second model over time.

18. The computing system of claim 14, wherein the selected process includes assessing accuracy of the model, and the processing circuitry is further configured to:
send, to a business unit computing system, alerts about model inaccuracies.

19. The computing system of claim 14, wherein the selected process includes assessing accuracy of the model, and wherein to send the control signals, the processing circuitry is further configured to:
send control signals to model retraining infrastructure to cause the model retraining infrastructure to retrain the model.

20. Non-transitory computer-readable media comprising instructions that, when executed, cause processing circuitry of a computing system to:
capture a sequence of model output data generated by a model, wherein the sequence of model output data includes information about a plurality of predictions made by the model, and wherein each prediction in the plurality of predictions is generated by the model in response to a different set of model input data;
select, based on configuration settings, a process to perform on the sequence of model output data, wherein the process is selected from a plurality of available processes;
perform the selected process, based on at least a portion of the sequence of model output data, to generate information about performance of the model over time; and
send, to a downstream system, control signals to modify operation of the downstream system based on the information about performance of the model over time.
